(19) United States
(12) Patent Application Publication
(10) Pub. No.: US 2018/0356959 A1
(43) Pub. Date: Dec. 13, 2018

(54) RATING AN ITEM WITH A COMMUNICATION DEVICE

(71) Applicant: Abraham Reichert, Modiin (IL)

(72) Inventor: Abraham Reichert, Modiin (IL)

(21) Appl. No.: 16/104,123

(22) Filed: Aug. 16, 2018

Related U.S. Application Data
(63) Continuation of application No. 14/078,587, filed on Nov. 13, 2013.

(51) Int. Cl. G06F 3/0481; G06Q 30/02; G06F 3/0484; G06Q 50/00

(52) U.S. Cl. CPC G06F 3/04817; G06Q 30/0282; G06Q 50/01; G06F 3/0484

(57) ABSTRACT

A set of icons for rating an item is provided. Each of the icons includes a thumb with a different angular rotation to where the thumb points. The different angular rotations are indications of different degrees of satisfaction with the item.

### CROSS-REFERENCE TO OTHER APPLICATIONS

This application claims priority from U.S. Provisional Patent Application 61/726,661, filed Nov. 15, 2012, and from U.S. patent application Ser. No. 14/078,587, filed Nov. 13, 2013, which are incorporated herein by reference.

### FIELD OF THE INVENTION

The present invention relates generally to providing a rating of an item with a communication device, and specifically to an icon (e.g., a thumb-up or thumb-down icon) used for rating an item.

### BACKGROUND OF THE INVENTION

Many methods are known in the prior art for rating content items, such as items on a social network (e.g., FACEBOOK), video content (e.g., songs, film clips, etc.) and many others, according to a user's expressed preferences. In general, rating involves assigning a Boolean rating of “like” or “dislike” to the particular item. Well-known examples include numerical ratings, such as a scale from one to ten, one being least favorite and ten being most favorite, and icons, such as a “thumbs up” for like and “thumbs down” for dislike.

### SUMMARY OF THE INVENTION

The present invention seeks to provide an improved icon (e.g., a thumb-up or thumb-down icon) for rating an item, as is described more in detail hereinbelow. In particular, the present invention seeks to provide an icon which provides a graduated indication of degree of liking an item.

There is thus provided in accordance with a non-limiting embodiment of the present invention an article including a set of icons for rating an item, each of the icons including a thumb with a different angular rotation to where the thumb points, wherein the different angular rotations are indications of different degrees of satisfaction with the item.

A maximum degree of satisfaction includes a thumb pointing up and a minimum degree of satisfaction includes a thumb pointing down and an intermediate degree of satisfaction includes a thumb pointing in a direction between up and down.

In accordance with a non-limiting embodiment of the present invention a color of the thumb changes in accordance with different degrees of satisfaction with the item.

In accordance with a non-limiting embodiment of the present invention a text associated with the thumb changes in accordance with different degrees of satisfaction with the item.

### BRIEF DESCRIPTION OF THE DRAWINGS

The present invention will be understood and appreciated more fully from the following detailed description taken in conjunction with the drawings in which:

FIG. 1 is a simplified pictorial illustration of an icon for rating an item, constructed and operative in accordance with an embodiment of the present invention;

FIG. 2 is a simplified pictorial illustration of an icon for rating an item, constructed and operative in accordance with another embodiment of the present invention;

FIG. 3 is a simplified pictorial illustration of an icon for rating an item, constructed and operative in accordance with yet another embodiment of the present invention;

FIG. 4 is a simplified pictorial illustration of an icon for rating an item, constructed and operative in accordance with still another embodiment of the present invention;

FIGS. 5A and 5B illustrate the basic rotatable thumb icon of FIG. 4 in two discrete positions with two related textual and color changes;

FIGS. 6A-6E illustrate rotation of the thumb and corresponding changes in color and text (percentage);

FIGS. 7A-7E illustrate five discrete steps with color and text changes with respect to the thumb rotation angle;

FIGS. 8A-8E are similar to FIGS. 6A-6E, but without color change; and

FIGS. 9A-9E illustrate just the rotation of the thumb without color or textual changes.

### DETAILED DESCRIPTION OF EMBODIMENTS

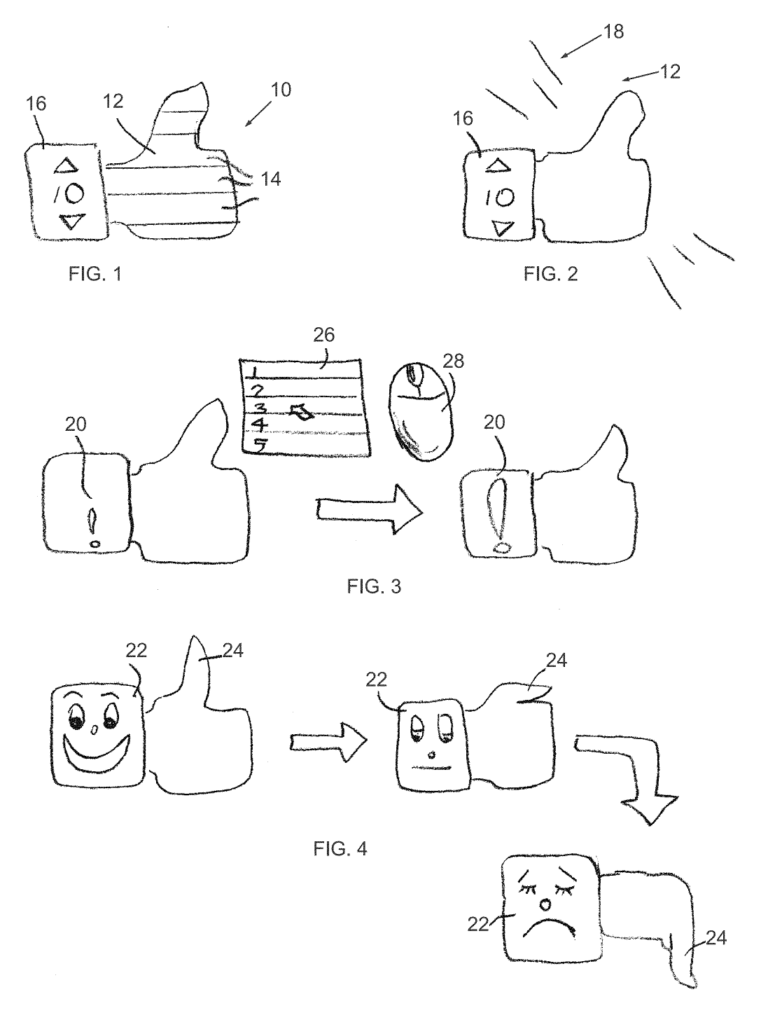

Reference is now made to FIG. 1, which illustrates an icon 10 for rating items, constructed and operative in accordance with an embodiment of the present invention.

Icon 10 is shown as a thumb sign, but it is appreciated that the invention is not limited to a thumb, and can include other indications, such as but not limited to, a star, ball, face, and many others. Icon 10 includes a graduated indication 12 of a degree of liking or disliking the item.

In the illustrated embodiment of FIG. 1, the graduated indication 12 includes levels of filling an interior space of icon 10. By gradually increasing the filling of the interior space, the user indicates a stronger liking of the item (or disliking of the item if the thumb is pointing down).

For example, the interior space may be filled with distinguishably different elements 14. For example, the elements 14 may differ by color (e.g., rainbow colors, shades of a certain color, different cross-hatching or diagonal line shading, etc.), contour, size or shape. In the illustrated embodiment, the graduated indication 12 further includes a numerical scale 16 adjacent icon 10. As the user increases the preference level, the numbers increase, for example, from 1 to 10.

Reference is now made to FIG. 2. In this embodiment, the graduated indication 12 includes different brightness levels 18 of the icon. Additionally or alternatively, the graduated indication 12 may include different colors or different sizes of the icon.

Reference is now made to FIG. 3. In this embodiment, the graduated indication includes graduated punctuation marks 20 adjacent icon 10.

Reference is now made to FIG. 4. In this embodiment, the graduated indication includes graduated levels of a caricature 22 associated with the icon. A thumb 24 of the icon points up when the highest level of preference is indicated. The thumb 24 is horizontal when the medium level of preference is indicated. The thumb 24 points down when the lowest level of preference is indicated.

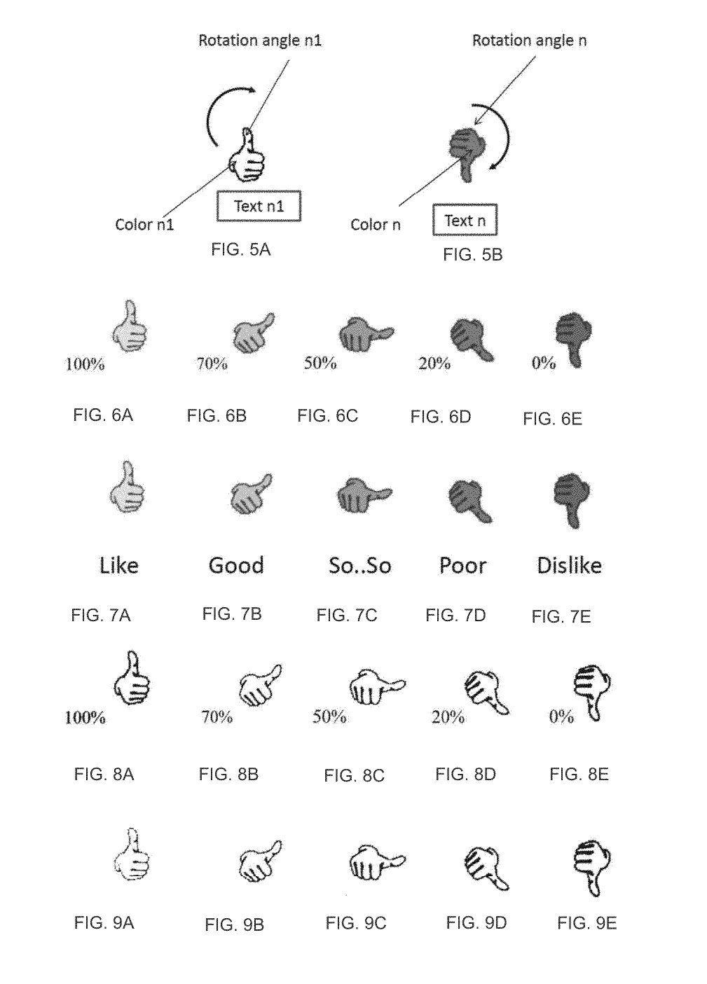

Reference is now made to FIGS. 5A and 5B, which show further features of the rotatable thumb icon of FIG. 4. The basic parameter for indicating the degree of satisfaction is the angular orientation of the rotatable thumb icon. This angular rotation, indicating to where the thumb points, changes with respect to the user degree of satisfaction, from thumb up (called the 0° position—rotation angle n1 in FIG. 5A) for the maximum degree of satisfaction (like) to thumb down (180°—rotation angle n in FIG. 5B) for the minimum amount of satisfaction (dislike).

Two other parameters may be added: color of the thumb icon (such as color n1 or color n) and/or text (such as text n1 or text n) (“text” includes a picture as in FIG. 4). For example, the color can change from green (or other color) for the maximum degree of satisfaction to red (or other color) for the minimum degree of satisfaction. The text that shows change of the degree of satisfaction can range from 100% to 0% or discrete words such as Like, Good, to Dislike, and so forth.

FIGS. 5A and 5B show the basic rotatable thumb icon in two discrete positions with two related textual and color changes.

FIGS. 6A-6E show rotation of the thumb and corresponding changes in color and text (percentage).

FIGS. 7A-7E show five discrete steps with color and text changes with respect to the thumb rotation angle.

FIGS. 8A-8E are similar to FIGS. 6A-6E, but without color change.

FIGS. 9A-9E show just the rotation of the thumb without color or textual changes.

As exemplarily shown in FIG. 3 (although these features hold for all embodiments), a pop-up window 26 on a screen can be used to select the graduated indication. Pop-up window 26 may be accessed by a pointing device, such as right-clicking on a mouse 28. As another example, scrolling the scroll button of the mouse 28 can be used to select the graduated indication. Of course, other pointing devices or other communication devices can be used to effect the selection and send the graduated indication to information receiver, such as but not limited to, friends, family, advertisers, publicity firms, places of businesses, points of sale, vendors, etc.

What is claimed is:

1. An article comprising:
a set of icons for rating an item, each of said icons comprising a thumb with a different angular rotation to where the thumb points, wherein the different angular rotations are indications of different degrees of satisfaction with the item.

2. The article according to claim 1, wherein a maximum degree of satisfaction comprises a thumb pointing up and a minimum degree of satisfaction comprises a thumb pointing down and an intermediate degree of satisfaction comprises a thumb pointing in a direction between up and down.

3. The article according to claim 1, wherein a color of said thumb changes in accordance with different degrees of satisfaction with the item.

4. The article according to claim 1, wherein a text associated with said thumb changes in accordance with different degrees of satisfaction with the item.

5. A method comprising:
using a set of icons for rating an item, each of said icons comprising a thumb with a different angular rotation to where the thumb points, wherein the different angular rotations are indications of different degrees of satisfaction with the item.

6. The method according to claim 5, wherein a maximum degree of satisfaction comprises a thumb pointing up and a minimum degree of satisfaction comprises a thumb pointing down and an intermediate degree of satisfaction comprises a thumb pointing in a direction between up and down.

7. The method according to claim 5, wherein a color of said thumb changes in accordance with different degrees of satisfaction with the item.

8. The method according to claim 5, wherein a text associated with said thumb changes in accordance with different degrees of satisfaction with the item.
